(19) United States
(12) Patent Application Publication
(10) Pub. No.: US 2012/0053941 A1
(43) Pub. Date: Mar. 1, 2012

(54) Wireless Voice Activation Apparatus for Surgical Lasers

(76) Inventor: Michael D. SWICK, Conneaut Lake, PA (US)

(21) Appl. No.: 13/219,650

(22) Filed: Aug. 27, 2011

Related U.S. Application Data
(60) Provisional application No. 61/377,551, filed on Aug. 27, 2010.

(51) Int. Cl. G10L 17/00

(52) U.S. Cl. 704/246; 704/E17.001

(57) ABSTRACT

A wireless voice activation surgical laser system utilizing wireless transmitter receivers. The present invention integrates wireless communication between a surgical laser, a voice recognition device, and a microphone to allow surgeons to verbally activate or deactivate a surgical laser. The voice recognition device is able to recognize a surgeons commands and relay the commands directly to the surgical laser.

The current application claims a priority to the U.S. Provisional Patent application Ser. No. 61/377,551 filed on Aug. 27, 2010.

### FIELD OF THE INVENTION

The present invention relates generally to a system apparatus for the activation of surgical lasers by means of voice activation. More specifically, a surgeon is able to use the present invention to verbally activate a surgical laser.

### BACKGROUND OF THE INVENTION

When dealing with surgeries or other operations, it is vital to the patient's health and survival that the operator is careful and stable. Additionally, a surgeon's quickness and accuracy contribute to the user's recovery and health after the operation. Surgical lasers offer a number of advantages for surgeons over the traditional scalpel. The surgical laser provides a constant and consistent light beam. This means that surgeon is able to easily make precise cuts at desired depth. With a traditional scalpel, the surgeon is required to concentrate on the amount or pressure is applied for incisions. Additionally, for surgical lasers, the hot light beams also offer a coagulating effect to prevent excessive bleeding. These benefits allow a surgeon to operate with quickness and precision. However, even with surgical lasers, the surgeon must be cautious to prevent misuse and malpractice. The surgical laser often includes a means of activations that do not involve the hands, as hand activation may affect a surgeon's steady hands. For example, foot-activation is an existing method for using a surgical laser. The current method of using foot activation for surgical lasers can still affect a surgeon's overall concentration on their hand stability during a surgery. Another method for activating surgical lasers is finger switches directly on the surgical laser. However, finger switches destroy hand sensitivity and precise movements by the hand are affected. The present invention aims to overcome such a potential risk of malpractice by completely replacing the need for physical activation of the surgical laser by the surgeon. Instead, the present invention offers a wireless means of activating a surgical laser by means of voice commands and voice recognition.

### BRIEF DESCRIPTION OF THE DRAWINGS

FIG. 1 is a schematic diagram of the present invention showing the communication between each device.

### DETAIL DESCRIPTIONS OF THE INVENTION

All illustrations of the drawings are for the purpose of describing selected versions of the present invention and are not intended to limit the scope of the present invention.

The present invention is a voice activation system for surgical lasers utilizing wireless transmitters and receivers that allows a surgeon to relay commands verbally directly to the surgical lasers. The surgical lasers are able to act based on the verbal commands provided by the surgeon. To achieve wireless communication with a surgical laser without the use of physical actuators and minimal effort to the surgeon the present invention comprises a surgical laser, a voice recognition device, and a microphone.

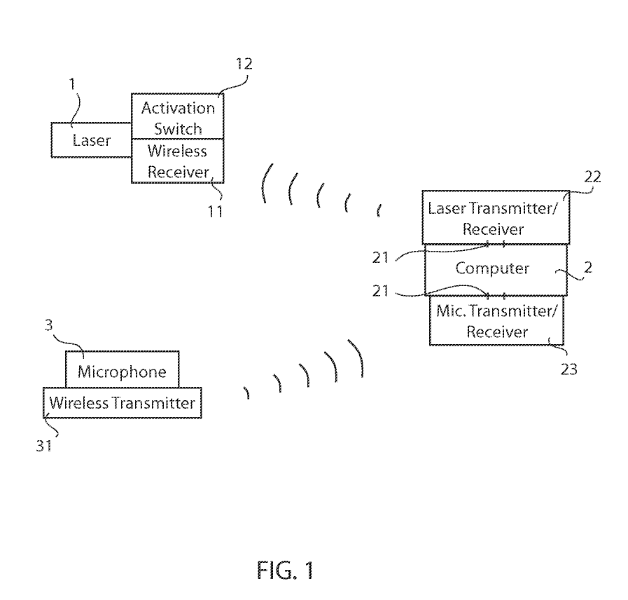

In reference to FIG. 1, the surgical laser comprises a laser wireless receiver and an activation device. The laser wireless receiver is directly connected to the activation switch. The laser wireless receiver provides the surgical laser with the means to receive wireless signals. The wireless signal received by the laser wireless receiver consists of data commands for interaction with the activation switch. The activation switch receives the data commands from the laser wireless receivers and acts accordingly to activate or deactivate the surgical laser.

The surgeon is able to communicate with the surgical laser by means of the microphone. In the preferred embodiment of the present invention, the microphone is wireless device that is worn on or integrated onto a surgeon's outfit. The microphone further comprises of a microphone wireless transmitter. The surgeon verbally communicates a command into the microphone that is to be relayed to the activation device on the surgical laser. As the microphone receives the verbal command from the surgeon, the command is translated into voice data that is transmitted to the voice recognition device by means of the microphone wireless transmitter.

The voice recognition device is a small computer that is able to process the voice data received from the microphone. The voice recognition device further comprises a plurality of ports, a wireless laser transmitter receiver, and a wireless microphone wireless transmitter receiver. The plurality of ports includes a first port and a second port. The wireless laser transmitter receiver is connected to the first port and the wireless microphone transmitter receiver is connected to the second port. The wireless laser transmitter receiver is wirelessly connected to the laser wireless receiver. The activation is connected to the laser wireless receiver. The wireless microphone transmitter receiver is connected with the microphone wireless transmitter. The voice recognition device utilizes voice recognition software to isolate the surgeon's voice from other sounds or noise. The voice recognition device receives the voice data from the microphone through the microphone wireless transmitter and the wireless microphone transmitter receiver. The program in the voice recognition device is able to filter noises other than the surgeon's voice to be translated into command data. The program used for the voice recognition device can be any top voice recognition software.

To ensure the voice recognition device is able to recognize the surgeon's voice, the voice recognition device requires prior calibration to recognize the frequency range of the surgeon's voice. This allows a surgeon to operate in a noisy environment without compromising the response of the surgical laser. Once the command has been isolated from the voice data, it is converted into command data to be transmitted to the laser wireless receiver by means of the wireless laser transmitter receiver. An example command the surgeon can verbally communicate to the surgical laser is “initiate lasing” and “stop lasing”. The command data is electrically communicated with the activation switch by the laser wireless receiver. The activation switch acts accordingly to the command data to activate and deactivate the surgical laser.

In the preferred embodiment of the present invention, the wireless receivers and transmitters are bluetooth devices. However, in other embodiments of the present invention, the wireless devices used for communication can be any other suitable wireless device suitable for quickly transmitting packets of data efficiently. It is important that each device respond quickly without lag as the surgical laser may create deeper incisions than needed. As a result, the recovery time for patients can potentially be lengthened. The present invention can be retrofitted into any existing surgical lasers or manufactured with new surgical lasers. The present invention presents an advantage for surgeons as it allows the surgeon to place full concentration into their hands while performing an operation without having the need to pay attention to their feet to activate or deactivate the surgical laser. By reducing the need for a foot pedal switch by means of a wireless voice activation system, clutter is also reduced in the operating room.

Although the invention has been explained in relation to its preferred embodiment, it is to be understood that many other possible modifications and variations can be made without departing from the spirit and scope of the invention as hereinafter claimed.

What is claimed is:

1. A wireless voice activation apparatus for surgical lasers comprises,
a surgical laser;
a voice recognition device;
a microphone;
the surgical laser comprises a laser wireless receiver and an activation switch;
the voice recognition device comprises a plurality of ports, a wireless laser transmitter receiver, and a wireless microphone transmitter receiver;
the microphone comprises a microphone wireless transmitter;
the plurality of ports having a first port and a second port;
the wireless laser transmitter receiver being connected to the first port; and
the wireless microphone transmitter receiver being connected to the second port.

2. The wireless voice activation apparatus for surgical lasers as claimed in claim 1 comprises,
the wireless laser transmitter receiver being connected with the laser wireless receiver; and
the activation device being connected to the laser wireless receiver, wherein command data is received by the laser wireless receiver through the voice recognition device.

3. The wireless voice activation apparatus for surgical lasers as claimed in claim 1 comprises,
the wireless microphone transmitter receiver being connected with the microphone wireless transmitter, wherein the voice recognition device is able to receive voice command data from the microphone wireless transmitter through the wireless microphone transmitter receiver.

4. A wireless voice activation apparatus for surgical lasers comprises,
a surgical laser;
a voice recognition device;
a microphone;
the surgical laser comprises a laser wireless receiver and an activation switch;
the voice recognition device comprises a plurality of ports, a wireless laser transmitter receiver, and a wireless microphone transmitter receiver;
the microphone comprises a microphone wireless transmitter;
the plurality of ports having a first port and a second port;
the wireless laser transmitter receiver being connected to the first port;
the wireless microphone transmitter receiver being connected to the second port;
the wireless laser transmitter receiver being connected with the laser wireless receiver; and
the activation device being connected to the laser wireless receiver, wherein command data is received by the laser wireless receiver through the voice recognition device.

5. The wireless voice activation apparatus for surgical lasers as claimed in claim 4 comprises,
the wireless microphone transmitter receiver being connected with the microphone wireless transmitter, wherein the voice recognition device is able to receive voice command data from the microphone wireless transmitter through the wireless microphone transmitter receiver.

6. A wireless voice activation apparatus for surgical lasers comprises,
a surgical laser;
a voice recognition device;
a microphone;
the surgical laser comprises a laser wireless receiver and an activation switch;
the voice recognition device comprises a plurality of ports, a wireless laser transmitter receiver, and a wireless microphone transmitter receiver;
the microphone comprises a microphone wireless transmitter;
the plurality of ports having a first port and a second port;
the wireless laser transmitter receiver being connected to the first port;
the wireless microphone transmitter receiver being connected to the second port;
the wireless laser transmitter receiver being connected with the laser wireless receiver;
the activation device being connected to the laser wireless receiver, wherein command data is received by the laser wireless receiver through the voice recognition device; and
the wireless microphone transmitter receiver being connected with the microphone wireless transmitter, wherein the voice recognition device is able to receive voice command data from the microphone wireless transmitter through the wireless microphone transmitter receiver.
